(19) United States
(12) Patent Application Publication
(10) Pub. No.: US 2017/0193810 A1
(43) Pub. Date: Jul. 6, 2017

(54) VIDEO EVENT DETECTION AND NOTIFICATION

(71) Applicant: WIZR LLC, Santa Monica, CA (US)

(72) Inventors: Song CAO, Los Angeles, CA (US); Genquan DUAN, Beijing (CN); David CARTER, Santa Monica, CA (US)

(73) Assignee: WIZR LLC, Santa Monica, CA (US)

(21) Appl. No.: 15/399,650

(22) Filed: Jan. 5, 2017

Related U.S. Application Data
(60) Provisional application No. 62/275,155, filed on Jan. 5, 2016.

(51) Int. Cl. G08B 29/18; G06K 9/62; G06F 17/30; G08B 13/196

(52) U.S. Cl. CPC G08B 29/185; G08B 13/196; G06K 9/6267; G06F 17/30858; G06F 17/3079

(57) ABSTRACT

A computer-implemented method to notify a user about an event is disclosed. The method may include monitoring a video and determining that an event occurs in the video and identifying one or more event data related to the event. The method may include comparing the one or more event data with one or more event data previously stored in a false alarm database. The method may include classifying the event as a false alarm event when the one or more event data is determined to be sufficiently similar to the event data previously stored in the false alarm database and classifying the event as not a false alarm event when the one or more event data is determined not to be sufficiently similar to event data previously stored in the false alarm database. The method may include notifying the user about the event when the event is classified as not a false alarm event.

### CROSS-REFERENCE TO A RELATED APPLICATION

This application claims the benefit of and priority to U. S. Provisional Application No. 62/275,155, filed on Jan. 5, 2016, titled “VIDEO EVENT DETECTION AND NOTIFICATION,” which is incorporated herein by reference in its entirety.

### BACKGROUND

Modern video surveillance systems provide features to assist those who desire safety or security. One such feature is automated monitoring of the video created by surveillance cameras. A video surveillance system may include a video processor to detect when events occur in the videos created by a surveillance camera system.

The subject matter claimed herein is not limited to embodiments that solve any disadvantages or that operate only in environments such as those described above. Rather, this background is only provided to illustrate one example technology area where some embodiments described herein may be practiced.

### SUMMARY

A computer-implemented method to notify a user about an event is disclosed. The method may include monitoring a video. The method may further include determining that an event occurs in the video. The method may further include identifying one or more event data related to the event. The method may also include comparing the one or more event data with one or more event data previously stored in a false alarm database. The method may further include classifying the event as a false alarm event when the one or more event data is determined to be sufficiently similar to the event data previously stored in the false alarm database. The method may also include classifying the event as not a false alarm event when the one or more event data is determined not to be sufficiently similar to event data previously stored in the false alarm database. The method may further include notifying the user about the event when the event is classified as not a false alarm event.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Disclosure is read with reference to the accompanying drawings.

FIG. 1 illustrates a block diagram of a system 100 for a multi-camera video tracking system.

FIG. 2 is a flowchart of an example process for event filtering according to some embodiments.

FIG. 3 shows an illustrative computational system for performing functionality to facilitate implementation of embodiments described herein.

### DISCLOSURE

Some embodiments in this disclosure relate to a method and/or system that may filter events. Systems and methods are also disclosed for notifying a user about events. For example, a system may monitor multiple video feeds, such as multiple video feeds from a camera surveillance system. In some embodiments, the system may include a series of events that are of interest to a user of the surveillance system. The events may be configured to include particular events that are of interest to the user.

The method and/or system as described in this disclosure may be configured to filter false positive events during the monitoring of the video based on one or more factors. As a result, the system may be configured to automatically filter false positive events based on the one or more factors such that the user of the system does not receive notifications for events that are not of interest to the user.

For example, in some embodiments, a video processor may monitor a video. For example, a surveillance camera may generate a video and send it to the video processor for monitoring. The video processor may also determine that an event occurs in the video. For example, the event may include a human moving through a scene or an object moving through a scene. The video processor may identify one or more event data related to the event. The video processor may compare the one or more event data with one or more event data previously stored in a false alarm database. For example, in some embodiments, the event data may include an identity of a human in the event. In these and other embodiments, the video processor may compare the identity of the human in the event with each identity of each human in false alarm database.

If the identity is determined to be sufficiently similar to an identity in the false alarm database, the event may be classified as a false alarm event. If the identity is determined not to be sufficiently similar to an identity in the false alarm database, the event may be classified as not a false alarm event. In some embodiments, event data may include object characteristics, object locations, a start and end time of the event and/or other data related to the event and/or related to objects associated with the event.

When the event is classified as not a false alarm event, the video processor may notify the user about the event. In some embodiments, an indication may be received from the user reclassifying the event as a false alarm event. For example, in some embodiments, the user may recognize the face of a person associated with the event and reclassify the event as a false alarm event. The video processor may update the false alarm dataset with the event data.

In some embodiments, the systems and/or methods described in this disclosure may help to enable the filtering of false positives in a video monitoring system. Thus, the systems and/or methods provide at least a technical solution to a technical problem associated with the design of video monitoring systems.

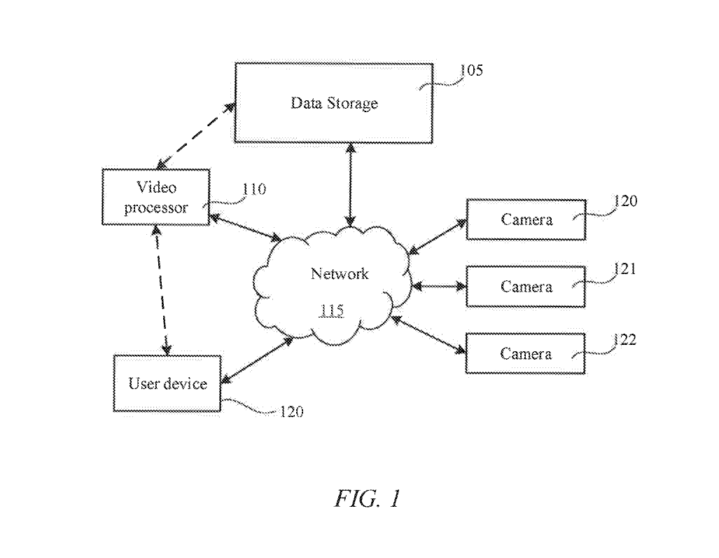

FIG. 1 illustrates a block diagram of a system 100 that may be used in various embodiments. The system 100 may include a plurality of cameras: camera 120, camera 121, and camera 122. While three cameras are shown, any number of cameras may be included. These cameras may include any type of video camera such as, for example, a wireless video camera, a black and white video camera, surveillance video camera, portable cameras, battery powered cameras, CCTV cameras, Wi-Fi enabled cameras, smartphones, smart devices, tablets, computers, GoPro cameras, wearable cameras, etc. The cameras may be positioned anywhere such as, for example, within the same geographic location, in separate geographic location, positioned to record portions of the same scene, positioned to record different portions of the same scene, etc. In some embodiments, the cameras may be owned and/or operated by different users, organizations, companies, entities, etc.

The cameras may be coupled with the network 115. The network 115 may, for example, include the Internet, a telephonic network, a wireless telephone network, a 3G network, etc. In some embodiments, the network may include multiple networks, connections, servers, switches, routers, connections, etc. that may enable the transfer of data. In some embodiments, the network 115 may be or may include the Internet. In some embodiments, the network may include one or more LAN, WAN, WLAN, MAN, SAN, PAN, EPN, and/or VPN.

In some embodiments, one more of the cameras may be coupled with a base station, digital video recorder, or a controller that is then coupled with the network 115.

The system 100 may also include video data storage 105 and/or a video processor 110. In some embodiments, the video data storage 105 and the video processor 110 may be coupled together via a dedicated communication channel that is separate than or part of the network 115. In some embodiments, the video data storage 105 and the video processor 110 may share data via the network 115. In some embodiments, the video data storage 105 and the video processor 110 may be part of the same system or systems.

In some embodiments, the video data storage 105 may include one or more remote or local data storage locations such as, for example, a cloud storage location, a remote storage location, etc.

In some embodiments, the video data storage 105 may store video files recorded by one or more of camera 120, camera 121, and camera 122. In some embodiments, the video files may be stored in any video format such as, for example, mpeg, avi, etc. In some embodiments, video files from the cameras may be transferred to the video data storage 105 using any data transfer protocol such as, for example, HTTP live streaming (HLS), real time streaming protocol (RTSP), Real Time Messaging Protocol (RTMP), HTTP Dynamic Streaming (HDS), Smooth Streaming, Dynamic Streaming over HTTP, HTML5, Shoutcast, etc.

In some embodiments, the video data storage 105 may store user identified event data reported by one or more individuals. The user identified event data may be used, for example, to train the video processor 110 to capture feature events.

In some embodiments, a video file may be recorded and stored in memory located at a user location prior to being transmitted to the video data storage 105. In some embodiments, a video file may be recorded by the camera and streamed directly to the video data storage 105.

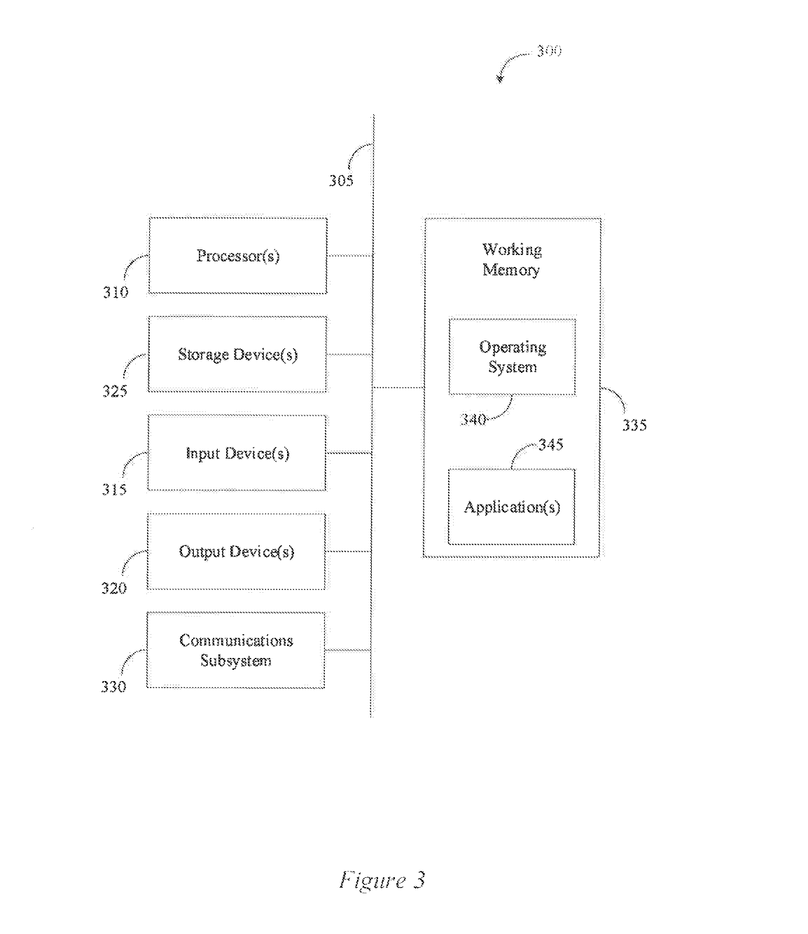

In some embodiments, the video processor 110 may include one or more local and/or remote servers that may be used to perform data processing on videos stored in the video data storage 105. In some embodiments, the video processor 110 may execute one more algorithms on one or more video files stored with the video storage location. In some embodiments, the video processor 110 may execute a plurality of algorithms in parallel on a plurality of video files stored within the video data storage 105. In some embodiments, the video processor 110 may include a plurality of processors (or servers) that each execute one or more algorithms on one or more video files stored in video data storage 105. In some embodiments, the video processor 110 may include one or more of the components of computational system 300 shown in FIG. 3.

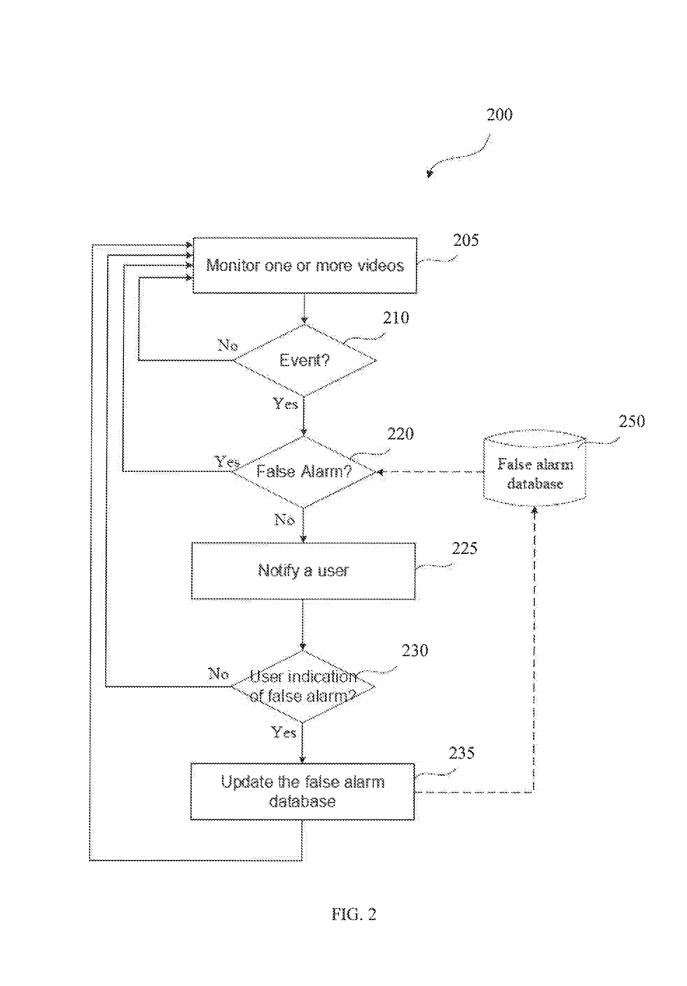

FIG. 2 is a flowchart of an example process 200 for event filtering according to some embodiments. One or more steps of the process 200 may be implemented, in some embodiments, by one or more components of system 100 of FIG. 1, such as video processor 110. Although illustrated as discrete blocks, various blocks may be divided into additional blocks, combined into fewer blocks, or eliminated, depending on the desired implementation.

The process 200 begins at block 205. At block 205 one or more videos may be monitored. In some embodiments, the videos may be monitored by a computer system such as, for example, video processor 110. In some embodiments, the videos may be monitored using one or more processes distributed across the Internet. In some embodiments, the one or more videos may include a video stream from a video camera or a video file stored in memory. In some embodiments, the one or more videos may have any file type.

At block 210 an event can be detected to have occurred in the one or more videos. The event may include a person moving through a scene, a car or an object moving through a scene, one or more faces being detected, a particular face leaving or entering the scene, a face, a shadow, animals entering the scene, an automobile entering or leaving the scene, etc. In some embodiments, the event may be detected using any number of algorithms such as, for example, SURG, SIFT, GLOH, HOG, Affine shape adaptation, Harris affine, Hessian affine, etc. In some embodiments, the event may be detected using a high level detection algorithm.

When an event is detected an event description may be created that includes various event data. The data may include data about the scene and/or data about objects in the scene such as, for example, object colors, object speed, object velocity, object vectors, object trajectories, object positions, object types, object characteristics, etc. In some embodiments, a detected object may be a person. In some embodiments, the event data may include data about the person such as, for example, the hair color, height, name, facial features, etc. The event data may include the time the event starts and the time the event stops. This data may be saved as metadata with the video.

In some embodiments, when an event is detected a new video clip may be created that includes the event. For example, the new video clip may include video from the start of the event to the end of the event.

In some embodiments, background and/or foreground filtering within the video may occur at some time during the execution of process 200.

If an event has been detected, then process 200 proceeds to block 215. If an event has not been detected, then process 200 returns to block 205.

At block 215 it can be determined whether the event is a false alarm event. In some embodiments, a false alarm event may be an event that has event data similar to event data in the false alarm database. The events data in the false alarm database may include data created using machine learning based on user input and/or other input. For example, the event data found in block 210 may be compared with data in the false alarm database.

If a false alarm event has been detected, then process 200 returns to block 205. If a false alarm event has not been detected, then process 200 proceeds to block 225.

At block 225 a user may be notified. For example, the user may be notified using an electronic message such as, for example, a text message, an SMS message, a push notification, an alarm, a phone call, etc. In some embodiments, a push notification may be sent to a smart device (e.g., a smartphone, a tablet, a phablet, etc.). In response, an app executing on the smart device may notify the user that an event has occurred. In some embodiments, the notification may include event data describing the type of event. In some embodiments, the notification may also indicate the location where the event occurred or the camera that recorded the event.

At block 230 the user may be provided with an interface to indicate that the event was a false alarm. For example, an app executing on the user's smart device (or an application executing on a computer) may present the user with the option to indicate that the event is a false alarm. For example, the app may present a video clip that includes the event to the user along with a button that would allow the user to indicate that the event is a false alarm. If a user indication has not been received, then process 200 returns to block 205. If a user indication has been received, then process 200 proceeds to block 235.

At block 235 the event data and/or the video clip including the event may be used to update the false alarm database and process 200 may then return to block 205. In some embodiments, machine learning techniques may be used to update the false alarm database. For example, machine learning techniques may be used in conjunction with the event data and/or the video clip to update the false alarm database. As another example, machine learning (or self-learning) algorithms may be used to add new false alarms to the database and/or eliminate redundant false alarms. Redundant false alarms, for example, may include false alarms associated with the same face, the same facial features, the same body size, the same color of a car, etc.

Process 200 may be used to filter any number of false alarms from any number of videos. For example, the one or more videos being monitored at block 205 may be a video stream of a doorstep scene (or any other location). An event may be detected at block 210 when a person enters the scene. Event data may include data that indicates the position of the person in the scene, the size of the person, facial data, the time the event occurs, etc. The event data may include whether the face is recognized and/or the identity of the face. At block 220 it can be determined that the event is a false alarm when the facial data is compared with facial data in the false alarm database. If there is a match indicating that the face is known, then the event is a false alarm and process 200 returns back to block 205. Alternatively, if the facial data does not match facial data in the false alarm data, then process 200 moves to block 230 and an indication can be sent to the user, for example, through an app executing on their smartphone. The user can then visually determine whether the face is known by manually indicating as much through the user interface of the smartphone. The facial data may then be used to train the false alarm database.

In other examples process 200 may determine whether a car of specific make, model, color, and/or with certain license plates is a known car that has entered a scene and depending on the data in the false alarm database the user may be notified.

In other examples process 200 may determine whether an animal has entered a scene and depending on the data in the false alarm database the user may be notified.

In other examples process 200 may determine whether a person has entered the scene between specific hours.

In other examples process 200 may determine whether a certain number of people are found within a scene.

In some embodiments, video processing such as, for example, process 200, may be sped up by decreasing the data size of the video being processed. For example, a video may be converted into a second video by compressing the video, decreasing the resolution of the video, lower the frame rate, or some combination of these. For example, a video with a 20 frame per second frame rate may be converted to a video with a 2 frame per second frame rate. As another example, an uncompressed video may be compressed using any number of video compression techniques.

In some embodiments, at block 230 the user may indicate that the event is an important event that they would like to receive notifications about. For example, if the video shows a strange individual mulling about the user's home during late hours, the user may indicate that they would like to be notified about such an event. This information may be used by the machine learning algorithm to ensure that such an event is not considered a false alarm and/or that the user is notified about the occurrence of such an event or a similar event in the future.

In some embodiments, video processing may be spread among a plurality of servers located in the cloud or on cloud computing process. For example, different aspects, steps, or blocks of a video processing algorithm may occur on a different server. Alternatively or additionally, video processing may be for different videos may occur at different servers in the cloud.

In some embodiments, each video frame of a video may include metadata. For example, the video may be processed for event and/or object detection. If an event or an object occurs within the video then metadata associated with the video may include details about the object or the event. The metadata may be saved with the video or as a standalone file. The metadata, for example, may include the time, the number of people in the scene, the height of one or more persons, the weight of one or more persons, the number of cars in the scene, the color of one or more cars in the scene, the license plate of one or more cars in the scene, the identity of one or more persons in the scene, facial recognition data for one or more persons in the scene, object identifiers for various objects in the scene, the color of objects in the scene, the type of objects within the scene, the number of objects in the scene, the video quality, the lighting quality, the trajectory of an object in the scene, etc.

The computational system 300 (or processing unit) illustrated in FIG. 3 can be used to perform and/or control operation of any of the embodiments described herein. For example, the computational system 300 can be used alone or in conjunction with other components. As another example, the computational system 300 can be used to perform any calculation, solve any equation, perform any identification, and/or make any determination described here.

The computational system 300 may include any or all of the hardware elements shown in the figure and described herein. The computational system 300 may include hardware elements that can be electrically coupled via a bus 305 (or may otherwise be in communication, as appropriate). The hardware elements can include one or more processors 310, including, without limitation, one or more general-purpose processors and/or one or more special-purpose processors (such as digital signal processing chips, graphics acceleration chips, and/or the like); one or more input devices 315, which can include, without limitation, a mouse, a keyboard, and/or the like; and one or more output devices 320, which can include, without limitation, a display device, a printer, and/or the like.

The computational system 300 may further include (and/or be in communication with) one or more storage devices 325, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 300 might also include a communications subsystem 330, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 330 may permit data to be exchanged with a network (such as the network described below, to name one example) and/or any other devices described herein. In many embodiments, the computational system 300 will further include a working memory 335, which can include a RAM or ROM device, as described above.

The computational system 300 also can include software elements, shown as being currently located within the working memory 335, including an operating system 340 and/or other code, such as one or more application programs 345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 325 described above.

In some cases, the storage medium might be incorporated within the computational system 300 or in communication with the computational system 300. In other embodiments, the storage medium might be separate from the computational system 300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 300 and/or might take the form of source and/or installable code, which, upon compilation and/or installation on the computational system 300 (e.g., using any of a variety of generally available compilers, installation programs, compression/decompression utilities, etc.), then takes the form of executable code.

The term “substantially” means within 3% or 10% of the value referred to or within manufacturing tolerances.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied-for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A computer-implemented method for notifying a user about an event, the method comprising:
monitoring a video;
determining that an event occurs in the video;
identifying one or more event data related to the event;
comparing the one or more event data with one or more event data previously stored in a false alarm database;
classifying the event as a false alarm event when the one or more event data is determined to be sufficiently similar to the event data previously stored in the false alarm database;
classifying the event as not a false alarm event when the one or more event data is determined not to be sufficiently similar to event data previously stored in the false alarm database; and
notifying the user about the event when the event is classified as not a false alarm event.

2. The method of claim 1, wherein the event includes one or more of the following: a person moving through a scene, a particular person leaving or entering a scene, a person not belonging to a predefined group leaving or entering a scene, an object moving through a scene, a face being detected, a particular face leaving or entering a scene, a face not belonging to predefined groups leaving or entering a scene, one or more animals entering a scene, a person entering a scene between specific hours, and a certain number of people are found in a scene.

3. The method of claim 1, wherein the event data includes one or more of the following: a color of an object related to the event, a speed of an object related to the event, a position of an object related to the event, a type of an object related to the event, a size of an object related to the event, characteristics of an object related to the event, a start time of the event, and an end time of the event.

4. The method of claim 1, wherein the event includes a person moving through a scene, a face being detected, a particular face leaving or entering a scene, and a person entering a scene between specific hours and wherein the event data include an identification of the person or face in the event, a height of the person in the event, a hair color of the person in the event, facial features of the person in the event, and a name of the person in the event.

5. The method of claim 1, wherein the event includes an automobile moving through a scene, an automobile remaining stationary in a scene, and an automobile entering a scene between specific hours and wherein the event data include a make of the automobile in the event, a size of the automobile in the event, a color of the automobile in the event, a model of the automobile in the event, and a license plate of the automobile in the event.

6. The method of claim 1, wherein the notifying the user about the event comprises sending the user the event data and presenting a clip of the video that includes the event.

7. The method of claim 1, further comprising:
decreasing the data size of the video being monitored; and
determining that an event occurs in the decreased data size video.

8. A computer-implemented method for notifying a user about an event, the method comprising:
monitoring a video;
determining that an event occurs in the video;
identifying one or more event data related to the event;
comparing the one or more event data with one or more event data previously stored in a false alarm database;
preliminarily classifying the event as a false alarm event when the one or more event data is determined to be sufficiently similar to the event data previously stored in the false alarm database;
preliminarily classifying the event as not a false alarm event when the one or more event data is determined not to be sufficiently similar to event data previously stored in the false alarm database;
notifying the user about the event when the event has been preliminarily classified as not a false alarm event;
receiving an indication from the user reclassifying the event as a false alarm event; and
updating the false alarm database with the event data.

9. The method of claim 8, wherein the event includes one or more of the following: a person moving through a scene, an object moving through a scene, a face being detected, a particular face leaving or entering a scene, one or more animals entering a scene, a person entering a scene between specific hours, and a certain number of people are found in a scene.

10. The method of claim 8 wherein the event data includes one or more of the following: a color of an object related to the event, a speed of an object related to the event, a position of an object related to the event, a type of an object related to the event, a size of an object related to the event, characteristics of an object related to the event, a start time of the event, and an end time of the event.

11. The method of claim 8, wherein the event includes a person moving through a scene, a face being detected, a particular face leaving or entering a scene, and a person entering a scene between specific hours and wherein the event data include an identification of the person or face in the event, a height of the person in the event, a hair color of the person in the event, facial features of the person in the event, and a name of the person in the event.

12. The method of claim 8, wherein the event includes an automobile moving through a scene, an automobile remaining stationary in a scene, and an automobile entering a scene between specific hours and wherein the event data include a make of the automobile in the event, a size of the automobile in the event, a color of the automobile in the event, a model of the automobile in the event, and a license plate of the automobile in the event.

13. The method of claim 8, wherein the notifying the user about the event comprises sending the user the event data and presenting a clip of the video that includes the event.

14. The method of claim 8, further comprising:
decreasing the data size of the video being monitored; and
determining that an event occurs in the decreased data size video.

15. A system for filtering events, the system comprising:
a network;
a false alarm database; and
a video processor configured to:
receive a video;
monitor the video;
determine that an event occurs in the video;
identify one or more event data related to the event;
compare the one or more event data with one or more event data previously stored in the false alarm database;
classify the event as a false alarm event when the one or more event data is determined to be sufficiently similar to the event data previously stored in the false alarm database;
classify the event as not a false alarm event when the one or more event data is determined not to be sufficiently similar to event data previously stored in the false alarm database; and
notify the user about the event when the event is classified as not a false alarm event.

16. The system of claim 15, wherein the event includes one or more of the following: a person moving through a scene, an object moving through a scene, a face being detected, a particular face leaving or entering a scene, one or more animals entering a scene, a person entering a scene between specific hours, and a certain number of people are found in a scene.

17. The system of claim 15, wherein the event data includes one or more of the following: a color of an object related to the event, a speed of an object related to the event, a position of an object related to the event, a type of an object related to the event, a size of an object related to the event, characteristics of an object related to the event, a start time of the event, and an end time of the event.

18. The system of claim 15, wherein the event includes a person moving through a scene, a face being detected, a particular face leaving or entering a scene, and a person entering a scene between specific hours and wherein the event data include an identification of the person or face in the event, a height of the person in the event, a hair color of the person in the event, facial features of the person in the event, and a name of the person in the event.

19. The system of claim 15, wherein the event includes an automobile moving through a scene, an automobile remaining stationary in a scene, and an automobile entering a scene between specific hours and wherein the event data include a make of the automobile in the event, a size of the automobile in the event, a color of the automobile in the event, a model of the automobile in the event, and a license plate of the automobile in the event.

20. The system of claim 15, wherein the notifying the user about the event comprises sending the user the event data and presenting a clip of the video that includes the event.
